(19) United States
(12) Patent Application Publication
(10) Pub. No.: US 2023/0018867 A1
(43) Pub. Date: Jan. 19, 2023

(54) COMPOSITE DOWN INSULATED ASSEMBLY FOR CONTROLLED ENERGY TRANSFER FROM AN INTEGRAL THERMAL SOURCE

(71) Applicant: Ronie REUBEN, Mont-Royal (CA)

(72) Inventor: Ronie REUBEN, Mont-Royal (CA)

(21) Appl. No.: 17/779,630

(22) PCT Filed: Nov. 26, 2019
(86) PCT No.: PCT/IB2019/060192

§ 371 Date: May 25, 2022

(51) Int. Cl. H05B 3/34; A41D 13/005; H05B 1/02

(52) U.S. Cl. CPC H05B 3/342; A41D 13/005; H05B 1/0272; H05B 2203/036; B60H 1/2227

(57) ABSTRACT

A composite light weight, flexible and energy efficient, thermal source energy transfer assembly for the transfer of thermal energy in articles of warmth or cold and its method of construction is described. The assembly comprises a thermal energy generating membrane having opposed top and bottom surfaces. A first thermally insulating flexible down material sheet is secured to the top surface. A second thermally insulating flexible down material sheet is secured to the bottom surface and wherein the first thermally insulating flexible down material sheet has a thermal insulating value superior to the second thermally insulating flexible down sheet to thermally insulate the thermal energy generating membrane from an ambient temperature side of the thermal source energy transfer assembly when retained adjacent a surface area of a user person to be heated or cooled by heat or cold released by the thermal energy generating membrane. The second thermally insulating flexible down material sheet absorbs and distributes thermal energy transferred thereto by the thermal energy generating membrane. Several assembly examples and applications are described.

### FIELD OF THE INVENTION

The present invention relates to heat or cold energy sources for heating or cooling a body to be heated or cooled thereby and more specifically to a composite light weight, flexible and energy efficient thermal source transfer assembly including down sheet insulating material and wherein the thermal source has a limited supply of thermal energy to be transferred against a body intended to receive the thermal energy.

### BACKGROUND OF THE INVENTION

It is known to fabricate articles of warmth such as jackets, sleeping bags, blankets and other articles with electrically conductive heating circuits integrated into a support material which is fasten to a fabric layer of the article to generate warmth. Such electrical heating circuits are secured to an ac or dc battery supply source. A controller device regulates the power supply to the heating circuit to control the heat generated to the article of warmth to provide comfort to a user person. It is also known to provide cooling pads in which is contained a gel pack which can be refrigerated to absorb cold and to release the cold when the pad is applied against a surface to be cooled. Such pads have many applications, such as in medical use or simply to provide a cool temperature to a person or any article requiring to be cooled. There are numerous other applications for such heating and cooling elements such as in industrial, commercial or leisure applications. Because of its variety of uses, such heating or cooling elements need to be fabricated differently to adapt to their intended use.

Several electrical wire thermal energy conductive material layers are known but these have proven to be bulky and difficult to integrate into articles of warmth and specially due to the fact that a battery supply and regulator device also needs to be integrated with the article of warmth. With the advent of new battery technology the size and weight of batteries has been greatly reduced but these batteries still have the disadvantage of having a short dc supply span and often require recharging. Accordingly, the heating time is dependent on the supply time of the batteries. In creasing the number of batteries also translates in other problems such a weight and storage and failures. Batteries are also expensive and prone to leakage.

Various types of heating elements have been developed to overcome some of these disadvantages and dependent on their intended use. One example is the use of conductive threads embroidered or knitted into patterns to provide localized heat for articles of apparel. Such heating materials are more expensive and have limited applications. It is also known to use thin flexible metal sheets, such as aluminum foils, but these have also proven costly. Thin film heaters are also described in U.S. Pat. No. 7,617,592 which describes a method and apparatus for the manufacture of thin film heaters and discusses the shortcomings of the prior art foil base film heater designs.

Conductive heating layers formed from conventional conductive ink composition s are also known but these have also proven to be costly depending on their compositions, such as the use of precious metals such as silver, which has excellent conductive heating properties. These conductive inks can be printed directly on an element to be heated and can resist flexion, for example when use to heat the seat of a vehicle. Because conductive ink is absorptive, it can be absorbed into an article to be heated and therefore requires additional coatings to form the conductive circuit and this can result in poor heating due to the fact that the layers may not be of uniform thickness. Also known in the art are conductive paints applied on fabric sheets. The problem with such paints is that they are subject to cracking and can therefore cannot be used on flexible applications where the material can be subject to folding and stretching. Such paints also decompose over tie due to their composition of chemicals.

Various types of non-electrically driven cooling elements are also known for use in cooling objects such as perishable meats, vegetables, pharmaceuticals or many other consumer items requiring cooling. Such cooling pads are also used for medical or non-medical applications by user persons for placement at an intended area of the body. A well-known type is the gel pack uses a cooling pouch containing a superabsorbent polymer having a liquid which swells when refrigerated by absorbing cold temperatures. These cooling gels also quickly absorb heat when placed against a surface or materials of warmer temperature and which required cooling. U.S. Pat. No. 10,172,739 issued Jan. 8, 2019 discloses a cooling or heating pad for placement at an intended area of the body. The pad is formed of a layer of highly conductive material which can be cooled or heated using a portable source of heat or cold material delivered to the conductive material by a delivery conduit. Such pads also require a thermal energy supply source for provide the heat or old energy to the pad and the material is highly conductive.

A problem with the above mentioned thermal energy conductive materials which are of the portable type, ie. the type requiring a portable power supply or an independent non-portable supply source to obtain its stored energy is that their supply of thermal energy is short lived due to the limitation of their portable power source or their construction whereby thermal energy is not efficiently utilized and lost to the environment. The construction of many of these thermal energy conductive materials is that they dispense of their energy quickly and in a non-controlled manner from all surfaces of its containment. They also lack in flexibility. There is therefore a need to improve on the construction and efficiency of thermal energy transfer of thermal energy conductive materials having a limited supply of thermal energy to be released for an intended use. These limited sources of thermal energy need to be encapsulated for directing their energy only in areas where it will provide benefit of the energy. By doing so waste energy is minimize and the source of the thermal energy will last longer. There is also a need to provide a more uniform distribution of the energy against an intended body to be heated or cooled.

It is well known in the art that down is the most efficient natural product that provides maximum warmth with minimal weight and can retain thermal energy longer than any other insulating products. Down is a fluffy material formed of clusters that trap air molecules in small pockets which create a thermal barrier. The clusters have tiny hairs that criss-cross in all directions and there are up to two million filaments for every ounce of down, and this structure can be compressed to be packed into very small spaces and then released to assume its natural loft. Down insulating material can breathe due to the air captured therein by the clusters. Duck, geese or swan are the only birds that can live in cold and tropical climates and its down provides heat in the winter time and coolness in the summer time.

In my U.S. Pat. No. 6,025,041 here is described the construction of a down feather sheet wherein the down is mixed with a binder to form a substantially homogeneous sheet for use as a thermal insulator. Being a homogeneous sheet of down it can provide a constant insulation factor throughout the sheet for the reason that there is no longer a need to secure the down from moving by forming stitch lines throughout the down sheet to maintain the down. Stitching lines or seams create cold spots due to the fact that there is no insulation in the area of the stitch seams. In my U.S. Pat. Nos. 9,380,893 and 10,390,637, I describe a new form of down feather sheet which has multi-directional stretchability. Accordingly, the down sheet stretches along with the material that it is secured to.

### SUMMARY OF THE INVENTION

It is a feature of the present invention to provide a composite light weight, flexible and energy efficient, thermal source transfer assembly which substantially overcomes many of the disadvantages of the above examples of the discussed prior art.

A further feature of the present invention is to provide a composite light weight, flexible and energy efficient, thermal energy source transfer assembly, of the portable type, having minimal thermal energy loss and efficient energy transition to a surface area of a body intended to receive the thermal energy from the thermal energy source.

A further feature of the present invention is to provide a composite light weight, flexible and energy efficient, thermal energy source transfer assembly wherein the thermal energy source is contained between a down feather sheet material or between two down feather sheets which reduces thermal energy loss from the energy source and improves on thermal energy containment and transfer to prolong the use of the thermal energy source.

Another feature of the present invention is to provide a composite light weight, flexible and energy efficient, thermal energy source transfer assembly for use in an article of warmth wherein to provide heat from the source more efficiently and transitioned to a an area of a person's body intended to receive the thermal energy while substantially preventing heat loss to the environment.

A still further feature of the present invention is to provide a composite light weight, flexible and energy efficient, thermal energy source transfer assembly formed of a flexible and stretchable thermal energy source held captive on a down feather sheet material or between two stretchable down feather sheets for use with articles subject to flexion and stretch.

Another feature of the present invention is to provide a composite light weight, flexible and energy efficient, thermal energy source transfer assembly which reduces energy draw from a battery supply providing longer time usage of the battery supply.

A still further feature of the present invention is to provide a composite light weight, flexible and energy efficient, thermal energy source transfer assembly having a novel construction wherein the thermal energy source is a thin film electrical heater fused on a down feather sheet.

Another feature of the present invention is to provide a composite light weight, flexible and energy efficient, thermal energy source transfer assembly wherein the thermal energy source is a gel or energy absorbing particles contained in a pack and held captive between opposed down feather sheets to reduce thermal energy loss and improve thermal energy transition between the source and a body to receive the thermal energy and further wherein the gel is capable of absorbing and releasing heat or cold energy.

A further feature of the present invention is to provide a composite light weight, flexible and energy efficient, thermal source energy transfer assembly and wherein the thermal energy generating membrane is one of a type having a limited supply of thermal energy.

Another feature of the present invention is to provide composite light weight, flexible and energy efficient thermal source energy transfer assembly wherein the conductive heating assembly is formed as a pad comprised of an envelope formed of polymeric material with a microwave responsive substance held captive in the envelope.

According to a still further feature of the present invention, there is provided a composite light weight, flexible, and energy efficient, thermal source energy transfer assembly and wherein there is provided sensing means to sense temperature values from the thermal energy generating membrane and a surface to be heated to provide temperature sensed signals to a controller to adjust the thermal energy generated by the electrically conductive heating assembly when the temperature value signals from a surface to be heated exceed the temperature value signals from the thermal energy generating membrane whereby to control the heat generated by the thermal energy generating membrane and thereby saving on the energy consumed by the thermal energy generating membrane to prolong the usefulness of a dc power supply source and to ensure that the surface is not overheated to cause scalding.

A still further feature of the present invention is to incorporate the composite light weight, flexible and energy efficient, thermal heat energy transfer assembly in a composite panel structure to provide heat to an adjacent space to be heated. Such panel structure can be used in the construction of road vehicles, aircrafts, buildings, etc and wherein the thermal energy generating membrane is powered by an ac or a dc power source.

Another feature of the present invention is to provide a composite light weight, and energy efficient, thermal source energy transfer assembly having a cold energy membrane to preserve cold energy in a space to be cooled, such as in a building structure, refrigerated enclosures, coolers, refrigerated trucks and containers and other refrigerated space applications.

According to the above features, from a broad aspect, the present invention provides a composite light weight, flexible and energy efficient, thermal source energy transfer assembly for the transfer of thermal energy in articles of warmth or cold. The thermal source energy transfer assembly comprises a thermal energy generating membrane having opposed top and bottom surfaces. A first thermally insulating flexible down material sheet is secured to the top surface. A second thermally insulating flexible down material sheet is secured to the bottom surface and wherein the first thermally insulating flexible down material sheet has a thermal insulating value superior to the second thermally insulating flexible down sheet to thermally insulate the thermal energy generating membrane from an ambient temperature side of the thermal source energy transfer assembly when retained adjacent a surface area of a user person to be heated or cooled by heat or cold released by the thermal energy generating membrane. The second thermally insulating flexible down material sheet absorbs and distributes thermal energy transferred thereto by the thermal energy generating membrane against the surface area to be heated or cooled.

According to another broad aspect of the present invention, there is provided a composite light weight, and energy efficient, thermal source energy transfer assembly for the transfer of thermal energy in a space to be heated or cooled to provide comfort. The thermal source energy transfer assembly comprises a thermal energy generating membrane having opposed inner and outer surfaces. A first thermally insulating flexible down material sheet is secured to the outer surface, and a second thermally insulating flexible down material sheet is secured to the inner surface. The first thermally insulating flexible down material sheet has a thermal insulating value superior to the second thermally insulating flexible down sheet to thermally insulate the thermal energy generating membrane from an external temperature side of the thermal source energy transfer assembly. The first thermally insulating flexible down material sheet is bonded to a surface area of a support structure. The second thermally insulating flexible down material sheet has a thermal energy conductive membrane secured to an outer surface thereof. The second thermally insulating flexible down material sheet absorbs and distributes thermal energy transferred thereto by the thermal energy generating membrane and releases the heat in a control manner through the thermal energy conductive membrane into an adjacent space to be heated or cooled.

According to a further broad aspect of the present invention, there is provided a method of constructing a composite light weight, flexible and energy efficient, thermal source energy transfer assembly for the transfer of thermal energy in articles of warmth or cold against a surface area to be heated or cooled. The method comprises the steps of:

i) providing a thermal energy generating membrane capable of generating thermal energy. The thermal energy generating membrane having opposed top and bottom surfaces,

ii) bonding a first thermally insulating flexible down material sheet to the top surface of said thermal energy generating membrane, and

iii) bonding a second thermally insulating flexible down material sheet to the bottom surface of the thermal energy generating membrane. The first thermally insulating flexible down material sheet has a thermal insulating value superior to the second thermally insulating flexible down sheet to thermally insulate the thermal energy generating membrane from an ambient temperature side of the thermal source energy transfer assembly. The second thermally insulating flexible down material sheet absorbs and distributes thermal energy transferred thereto by the thermal energy generating membrane in the direction of the surface area to be heated or cooled.

### BRIEF DESCRIPTION OF THE DRAWINGS

A preferred embodiment of the present invention is described with reference to the examples thereof as illustrated by the accompanying drawings in which.

FIG. 1 is a cross-section view illustrating an example of the construction of the composite light weight, flexible and energy efficient, thermal source energy transfer assembly of the invention produced in sheet form;

FIG. 2 is a section view showing the composite thermal sheet of FIG. 1 formed as a heating panel connected to a dc power supply source in the form of a battery pack;

FIG. 3 is a further example of the construction of the composite thermal sheet and herein containing temperature sensors and a controller to control the temperature generated against a surface area of a wearer person and to control the consumption of energy from a limited portable power supply source;

FIG. 4 is a simplified illustration showing panels of an article of apparel into which panels is integrated the composite light weight, flexible and energy efficient, thermal source energy transfer assembly of the invention;

FIG. 5 is a simplified plan view showing an electrical printed circuit secured to an electrically insulating and non-conductive support film or sheet and wherein the electrical circuit is configured to provide heat in designated areas of a wearer person's body;

FIG. 6 is a fragmented cross-section view showing the construction of a heat pad constructed in accordance with the present invention and containing a thermal energy source formed by microwave energy absorbing particles encapsulated in the pad and wherein the pad is provided with attaching means;

FIG. 7 is a cross-section view of a further example of the composite light weight, flexible and energy efficient, thermal source energy transfer assembly and wherein there is further provided a thermal reflective film bonded to an outer surface of the outer down material layer or sheet;

FIG. 8 illustrates a still further example of the construction of the composite light weight, flexible and energy efficient, thermal source energy transfer assembly provided with outer adhesive and flexible scrim sheets bonded to an outer shell and an inner liner of an article of warmth;

FIG. 9 is a fragmented plan view showing the component parts of a composite support structure, herein a panel structure incorporating the composite light weight, flexible and energy efficient, thermal source of the present invention;

FIG. 10 is a cross-section view illustrating an example of the composition of the elements in the construction of the composite panel of FIG. 9;

FIG. 11 is a fragmented plan view showing the component part of a composite support structure, herein a wall structure of a refrigerated enclosure incorporating the composite, light weight, energy efficient transfer assembly;

FIG. 12 is a cross-section view illustrating an example of the assembly of the elements in the construction of the composite support structure of FIG. 11, and

FIG. 13 is a further cross-section view illustrating a modification of the assembly of FIGS. 11 and 12 wherein a reflective sheet is incorporated in the assembly to reflect cold inwardly of the refrigerated enclosure or to reflect heat outwardly of the enclosure or to reflect both wherein the reflective sheet has opposed reflective surfaces.

### DETAILED DESCRIPTION OF THE INVENTION

Articles of warmth on the type utilizing a heat source or a cold source to transfer the thermal energy release thereby to a surface area of a person's body to provide warmth or cold are known. Examples of these are articles of apparel containing electrical conductors powered by portable battery packs to keep a person warm during cold winter months. Sleeping bags are also known equipped with such heating means. Another example are pads or pouches containing particulate matter that can be heated by microwave radiation and applied against a body part to relieve pain. Cold packs are also know to provide cold thermal energy against an injured part of a person's body. These pads can also be positioned in pouches provided in an article of apparel, such as a jacket or pants to generate the thermal energy at specific locations of the body of a wearer person. A disadvantage of such articles is that they lose efficiency for the reason that they radiate thermal energy in a non-controlled manner which limits the time of usefulness of the energy source and also which limits the time of usefulness of batteries used to power the heat generating electrical source. Often fifty percent or more of the energy release is lost to the environment. If most of that lost energy could be made to good use, then the efficiency of the article of warmth or cold can be greatly increased resulting in a longer period of use of the heating or cooling article. If the article of warmth is of a type using a portable dc battery supply, then by controlling the time of use of the batteries by modulating its supply in relation to the heat being transferred by the heating conductors, the useful time of the batteries can be prolonged.

The present invention provides a solution to the above deficiencies of such heating or cooling energy sources by packaging the thermal energy sources in a novel assembly using light weight, flexible and energy efficient down material sheeting of homogeneous construction. The composition of the such down material sheets is described in my previous U.S. Pat. Nos. 6,025,041, 9,380,893 and 10,390,637 and comprise generally of down material mixed with a binder and heat fused together in sheet form. The contents of these patent references are herein incorporated by reference.

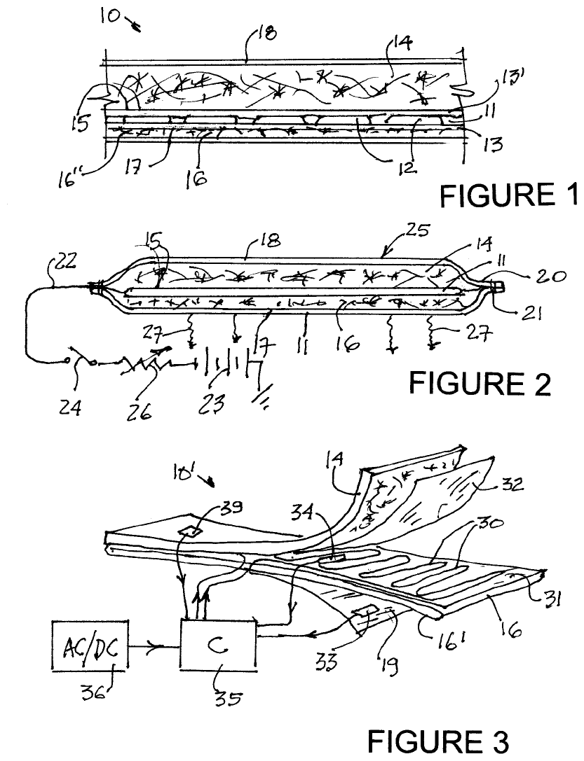

FIG. 1 illustrates at 10, the construction of the composite light weight, flexible and energy efficient assembly for the transfer of thermal energy from a thermal energy generating membrane 11, herein constituted by electrical conductors 12 mounted on a non-electrically conductive sheet or film 13 or between two such sheet or film 13′. As shown in FIG. 1, a first or outer thermally insulating flexible down material sheet 14 is secured to a top surface 15 of the energy generating membrane 11. A second or inner thermally insulating flexible down material sheet 16 is secured to a bottom surface 17 of the film 13 of the energy generating membrane 11. The securement of the down material sheets can be made by different bonding means, such as by glue, heat fusing, etc. As shown, the outer down material sheet 14 is thicker than the bottom down material sheet 17 and therefore presents a superior thermal insulating value than the bottom down material sheet whereby to thermally insulate the energy generating membrane 11 from ambient temperature or an outer cold side of the assembly 10. The purpose of the bottom down material sheet 17 is to provide comfort when positioned on a surface area of a user person's body part and more importantly to absorb heat or cold from the energy generating membrane 11 and distribute the thermal energy being transferred from the membrane 11 against or adjacent to the surface area be heated or cooled. The composition of the materials in the bottom or inner down material sheet 16 may include thermally conductive fibers 16″, such as aluminum fibers, to provide improved thermal conductivity of the insulation. The ratios of the thermal insulation values between the outer and inner down material sheets can vary depending on the applications or intended use of the assembly 10. For example, is the assembly is to be used in the construction of a sleeping bag, the outer down material sheet may have twice the insulation value as the inner down material sheet. Generally, the inner down material sheet can be said to have about 50 percent of the thermal insulation value as the outer down material sheet.

FIG. 2 illustrates an electrical energy generating membrane 11′ disposed between or sandwiched between the outer down material sheet 14 and the inner down material sheet 17 in a pouch 25 formed by interconnecting an outer scrim sheet 18, formed of a non-air permeable material, to an inner scrim sheet 19, formed of an air-permeable material, along outer peripheral extension flaps 20 by stitching 21 or other fastening means to hold the energy generating membrane 11′ captive. The electrical energy generating membrane 11′ has an electrical cable 22 attached to its conductors 12 and to a dc battery or battery pack 23 through a switch 24 and optionally also through a voltage variable control 26 to regulate the temperature generated by the membrane 11′. Because the energy generating membrane 11′ is superiorly insulated on its outer or top surface 15 most of its thermal energy, illustrated by reference numeral 27 will be dissipated towards its bottom surface 17 and out of the pouch 25 through its bottom air permeable scrim sheet 19 which is positioned adjacent or in contact with the surface area intended to receive the thermal energy of the membrane 11′. Accordingly, the lost of thermal energy from the membrane 11′ is substantially reduced and the limited supply of energy from the dc battery pack 23 is extended by conserving energy and regulating the supply of energy from the battery pack 23.

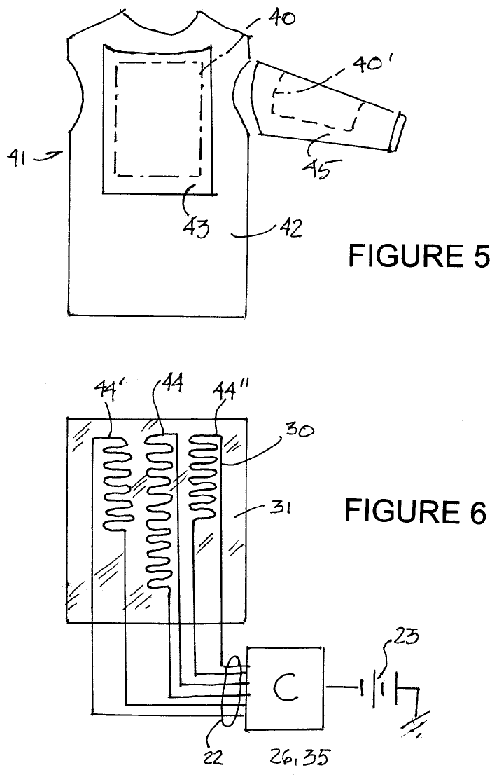

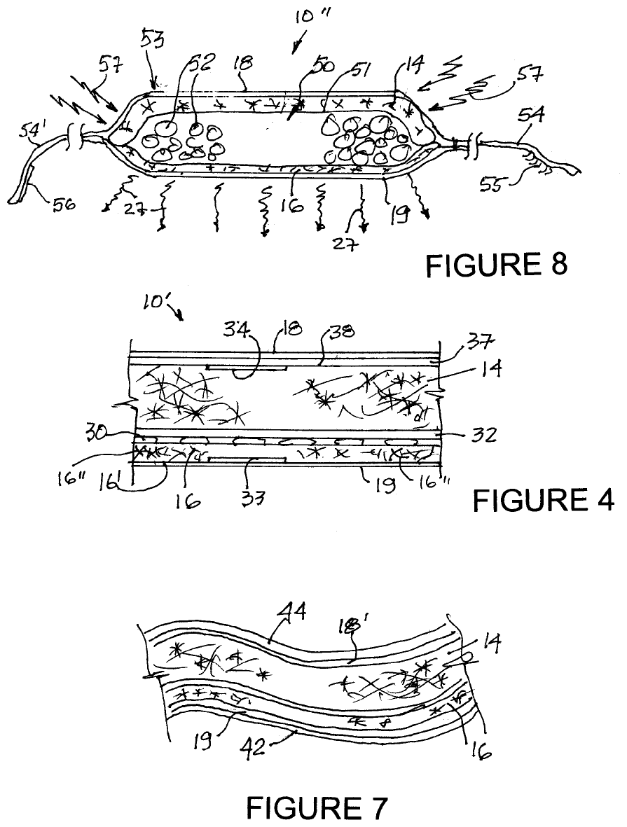

FIGS. 3 and 4 illustrates another example of the construction of assembly 10′ wherein a printed circuit 30 is fused on a substrate constituted by a flexible non-electrically conductive and flexible film material support sheet 31. The printed circuit 30 can be in the form of a conductive ink, as is well known in the art. Aluminum oxide is a highly conductive powder formed of small beads that can be deposited and adhered to the support sheet 31. An outer insulating protective substrate herein a film 32 is bonded over the printed circuit and the support sheet 31. When the printed conductive circuit 30 is rendered electrically conductive, heat is released into the inner down material sheet 16 and out through the inner air-permeable scrim sheet 19. The air-permeable scrim sheet 19 may be constructed as a stretchable adhesive scrim sheet bonded to the bottom surface 17 of the inner down material sheet 16. The flexible material sheet 31 is a thin layer of a carbon or graphene metal or a material having similar temperature conductive properties. The much thicker outer down material sheet 14 is bonded over the outer insulating film 32.

As also shown in FIGS. 3 and 4, a temperature sensor 33, in the form of a chip thermistor is bonded onto the inner scrim sheet 19 and held against the lower surface 17 of the down material sheet 16 to sense the temperature value at the surface 17. A further temperature sensor 34 is bonded on the support sheet 31 and under the insulating film 32 to send temperature value signals to a control device 32 connected to the power source 36 to control the temperature generated by the assembly 10′ by controlling the supply of energy to the conductive printed circuit 30. By monitoring the temperature released from the lower surface of the inner down material sheet a substantially constant temperature can be generated by the assembly by switching the supply “on” and “off”.

A further temperature sensor 39 may also secured to the outer surface of the outer down material sheet 14 to monitor outside temperature and by the use of a variable control (not shown but obvious to a person skilled in the art), control the amount of energy fed to the thermal energy generating membrane or conductive circuit to provide comfort to a user person as being monitored by the control 35 receiving input temperature signals from the sensor 33. As herein shown, the supply can be an ac supply from a household electrical socket or a dc supply from a battery source. If a dc battery supply, then the duration of use of the battery is extended by the control of the temperature generated by the energy generating membrane, herein the electrically conductive circuit.

FIG. 4 illustrates further modification of the assembly 10′ and wherein a thermal reflective film 37 is bonded between the top surface 38 of the outer down material insulating sheet 14 and an outer scrim sheet 18 of non air-permeable material to prevent the escape of heat from the assembly and into outside ambient air. The reflective film 37 is a flexible and pliable polyester type film having a reflective surface or Mylar, registered trademark, metalized on one side or a thermoplastics material having a reflective side Such thermoplastics material is a plyethelyene terapthalate aluminized film having a reflective metal evaporated on one side of the film to give it reflective properties.

In a still further embodiment, the composite light weight, flexible and energy efficient thermal source energy transfer assembly 10 and 10′, the thermally insulating down material sheets are formed with a binder exhibiting stretchability, and the scrim sheets 18 and 19 are also stretchable and have adhesive properties to bind respectively to an outer shell material and an inner lining material of an article of warmth or cold.

Referring now to FIGS. 5 to 7, there is illustrated an example of an application of the composite light weight, flexible and energy efficient, thermal energy source energy transfer assembly 10′ of the invention. As herein illustrated, the assembly 10′ is formed as a heating panel 40 constructed integrally with parts of an article of apparel, herein a body covering portion of a jacket 41 to be formed. The outer or bottom surface 16′ of the bottom down material sheet 16 is bonded on an inner lining 42 of the jacket to be formed, by adhesive or heat fusing or by an adhesive web, not shown but described in one of my co-pending patent applications. An air impermeable panel 43 may be secured over the heating panel 40 or an outer shell material pattern sheet 44 may be secured there over, see FIG. 7. A heating opad 40′ may also be secured in the like manner between the outer shell and inner lining of a sleeve portion 45 of the jacket or to leg portions, not shown, of pants.

The thermally conductive electric conductive circuit 30 mounted on the support sheet 31 may have different shapes, one being illustrated in FIG. 6, to provide heat at different areas of a wearer person's body. As shown in FIG. 6 there are three different electrically conductive circuits 44, 44′ and 44″ wherein to provide heat to the back area of a wearer person's body. The circuit 44 is a long conductive circuit intended to provide heat along the spine area of the wearer's body where there are nerve endings to provide a biological heat sensation for relaxation. The adjacent circuits 44′ and 44″ provide heat to the lung areas of the body to generate a heat treatment and to keep a wearer person comfortable during cold winter months.

As shown in FIG. 7, the outer down material sheet 14 and the inner down material sheet 16 each have a stretchable adhesive scrim 18′ and 19′ bonded to their outer surfaces whereby to attach the composite light weight, flexible and energy efficient thermal source energy transfer assembly directly on the opposing surface of the outer shell 44 and the inner liner 42 whereby it can be displaced therewith and flex with the materials to which it is bound to.

Referring now to FIG. 8, there is shown another example of the construction of the composite assembly 10″ of the present invention. As herein illustrated, thermal energy generating membrane is in the form of a pad 50. The pad 50 is formed by a flexible material envelope 51 formed of a suitable material such as polymeric material water proof material or natural materials such a cotton sheet, etc., and containing therein heat absorptive material 52 capable of absorbing heat when exposed to heat in a heated enclosure or exposed to microwave radiation. The heat absorptive material may be particulate material capable of retaining heat from a microwave radiating source or liquid material capable of absorbing heat, such as glycerol and polyethylene glycols or equivalents. The microwave responsive particulate material may be comprised of beads of activated alumina mixed with glycol and water in predetermined proportions for delivering a temperature of about 105 degrees Fahrenheit or greater for 25-30 minutes when subjected to microwave radiation in the order of about 700 watts for 3 minutes.

For cooling applications, the pad 50 may encapsulate a gel retained in a flexible envelope 51 which when frozen exhibits flexibility. The envelope is held captive between the outer down material sheet 14 and the inner down material sheet 16 in an outer pouch 53 formed of suitable fabric material. The outer pouch may also be formed as a rectangular pouch or other form having opposed integrally formed strapping belts 54 and 54′ each of which is provided with fasteners for interconnection together to hold the pad 50 firmly attached to a specific area of a person's body, such as an arm, leg, neck, head or other body parts requiring heat or cold treatment. The fasteners as herein illustrated are formed of complimentary “Velcro”, registered trademark, with one fastener constituted by hooks 55 and the other by felt material 56. As is shown in FIG. 8 the composite assembly 10″ shields the heating membrane from the ambient air 57 by its thicker outer down material sheet 14 and transfers a substantially uniform supply of heat or cold through its much thinner inner down material sheet 16 and its air permeable lower scrim sheet 19.

The method of constructing the composite light weight, flexible and energy efficient, thermal source energy transfer assembly 10 for the transfer of thermal energy in articles of warmth or cold against a surface area of a person's body to be heated or cooled can be summarized as follows. A thermal energy generating membrane 11, capable of generating thermal energy either in the form of heat or cold, is provided. The membrane has opposed top and bottom surfaces and an outer thermally insulating flexible down material sheet 14 is bonded to the top surface of the thermal energy generating membrane. A bottom thermally insulating flexible down material sheet 16 is bonded to the bottom surface 17 of the thermal energy generating membrane The outer thermally insulating flexible down material sheet 14 has a thermal insulating value superior to bottom thermally insulating flexible down sheet 16 to thermally insulate the thermal energy generating membrane from an ambient temperature side of the thermal source energy transfer assembly. The bottom thermally insulating flexible down material sheet 16 absorbs and distributes thermal energy transferred thereto by the thermal energy generating membranel 1 against the surface area to be heated or cooled. A scrim sheet 19 of suitable soft material provides contact against the skin of a wearer person when the thermal energy assembly is intended to be applied directly on a user person's skin. Various forms of energy generating membranes are intended to be covered by the present invention the description of specific examples of some of these is not intended to restrict the invention, and it is contemplated that different energy generating membranes may be used in the assembly.

As described above, temperature sensors may be incorporated in the assembly between the outer thermally insulating flexible down material sheet and said top surface of said thermal energy generating membrane, and also on an outer surface of the bottom thermally insulating flexible down material sheet 16. These sensors generate sensed temperature values to an intelligent programmed control to which operates switching means to regulate the voltage supplied by an electrical power source, such as dc batteries, to the thermal energy generating membrane to maintain a substantially constant desired temperature against a surface are to be heated. A thermal reflective film 37 may be integrated in the assembly and disposed against an outer surface of the outer insulating flexible down material sheet 14 to reflect heat in the direction of the thermal energy generating membrane.

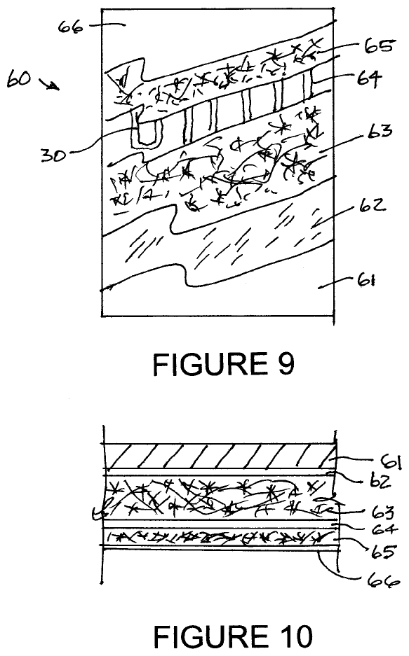

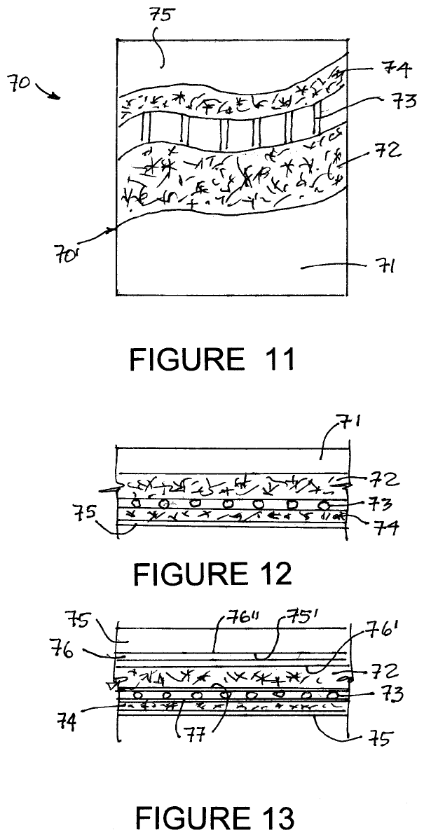

Referring now to FIGS. 9 and 10, there is illustrated another example of the preferred embodiment wherein the composite light weight, flexible and energy efficient, thermal source energy transfer assembly 10 is incorporated in a composite panel construction 60. An example of the composition of such panel 60 is illustrated and is composed of a support structure, herein a backing panel 61 of suitable material depending on the intended use of the support structure. The backing panel 61 may be formed of rigid material, such a wood or rigid plastic sheeting or flexible materials, such as plastics. It may also be of a molded shape as the composite assembly of the present invention is flexible to adapt to irregular molded shapes. Over the backing panel 61, there is bonded a heat reflective foil 62 whereby to reflect heat back into the outer down material sheet 63 bonded thereto. A thermal energy membrane 64 has an outer surface 64″ bonded to the inner surface 63′ of the down material sheet 63. An inner down material sheet 65 is bonded onto the inner surface 64′ of the thermal energy membrane 64. Finally, an outer thermal energy transfer membrane, herein a heat transfer material membrane or sheet 66 is secured over an outer surface 65′ of the inner down material sheet 65. The sheet 66 may be constructed of several materials depending on the use of the panel, but it is of a material capable of absorbing heat, in this illustrated application, or cold in the application of FIGS. 11 to 13 described herein below.

The composite panel construction 60 may have variations in its construction strata or layers depending on the intended use thereof. For example, the panel may be shaped for use in the construction of the inner walls of the passenger section of the fuselage of an aircraft or used in the construction of doors or roof panels of a road vehicles, or boats, etc. The thermal energy membrane may also be powered by a battery or battery bank or an ac power supply.

Referring now to FIGS. 11 and 12, there is illustrated a further application of the thermal energy insulating assembly and wherein it is utilized to retain cold energy in enclosures to be cooled. Examples of such enclosure are building spaces to provide comfort to its occupants, refrigerated enclosures such as coolers to maintain foodstuff cool, refrigerated trucks for transport of elements requiring refrigeration, refrigerated shipping containers and many other enclosures which requires the maintenance of cold temperatures. FIGS. 11 and 12 illustrated an example of the construction or assembly of a composite energy efficient thermal source energy transfer structure 70, herein in the form of a panel 70′. However, the structure may be in the form of a wall or wall section of a building or a refrigerated container or truck, or a cooler container to mention a few application thereof, but there are many other applications of an obvious nature.

As shown in FIG. 11, the panel 70′ is comprised of an outer wall structure, herein a panel board 71 on which there is retained by glue a first thermally insulating and flexible down material sheet 72. A cooling membrane in the form of a cooling coil 73, of a refrigerating compressor not shown, but obvious to a person skilled in the art is disposed and held in place by suitable means over the down material sheet 72. A second thermally insulating and flexible down material sheet 74 is secured over the cooling coils and the first down material sheet 72 and constitutes an inner insulated sheet adapted to face an enclosure to be cooled. For some applications, a thermal energy conductive membrane 75, as herein illustrated, is secured over the outer surface 74′ of the inner down material sheet 74. The density or thickness of the first and inner down material sheets, 72,74, can vary with respect to one another depending of the application, but generally, the first or outer down material sheet 72 would have a greater insulating value than the inner down material sheet 74 for the reason that it is closer to outer environment where the temperature is expected to be warmer. This assembly constitutes an example of the thermally insulated refrigerating panel.

The panel 70′ may have several uses, such as forming part of a wall of a room to be refrigerated. Several of these panels 70′ may be located at strategic position in the walls about such a room. On the hand, the support structure may be in the form of wall sheeting instead of a panel 70′ with the first thermally insulating down material sheet supported thereover, such as when applying insulation between studs when constructing walls of a building and securing refrigerating coils thereover with the inner down material sheet then bonded over the coils. The support structure may also be in the form of an outer wall of a cooler, with the outer wall being lined with the assembly of the first down material sheet 72, the cooling coil(s) 73 and the inner down material sheet 74. A suitable inner thermal energy conductive wall or membrane 75 would be constituted by the inner wall of the cooler.

With reference to FIG. 13, there is illustrated further modifications of the thermal energy transfer assembly structure 70 wherein a reflective a cold energy reflective material sheet 76 is bonded between an inner surface 75′ of the support structure and the first thermally insulating flexible down material sheet 71 with its reflective surface 76′ facing the first thermally insulating flexible down material sheet 71 to minimize cold energy loss through said support structure 75. The reflective material sheet 76 may also be a composite material sheet having opposed reflective surfaces 76′ and 76″ as herein illustrated. As shown, the reflective surface 76″ faces the external temperature side or outer wall structure 75 of the thermal source energy transfer assembly to reflect external temperature back into the support structure whereby to form a further insulating barrier.

FIG. 13 illustrates a further modification wherein a waterproof membrane 77, such as TEFLON, registered trademark, is interposed on opposite side of the refrigerated coils 73 to trap condensation and release it though an outlet conduit not shown for drainage. It is also contemplated that to insulate against outer warm temperatures, an insulating barrier can be provided in the form of a gas panel held captive between sealed aluminum sheets with outer down material held therebetween. The gas would constitutes a further insulator, such as we find in windows of building structures, Such inert gases can be argon, zeon, krypton, carbon dioxide or suitable gases having similar characteristics.

Although various applications of the composite light weight, flexible and energy efficient, thermal source energy transfer assembly, constructed in accordance to the examples described herein, have been mentioned and illustrated, it is not intended to limit their applications to these as some applications can be found, for example, in the construction of buildings, etc., where they may be integrated as heating panels.

It is within the ambit of the present invention to cover any modifications of the examples of the preferred embodiment described and illustrated herein, provided such modifications fall within the scope of the appended claim.

1. A composite light weight, flexible and energy efficient, thermal source energy transfer assembly for the transfer of thermal energy in articles of warmth or cold, said thermal source energy transfer assembly comprising a thermal energy generating membrane having opposed top and bottom surfaces, a first thermally insulating flexible down material sheet secured to said top surface, a second thermally insulating flexible down material sheet secured to said bottom surface and wherein said first thermally insulating flexible down material sheet has a thermal insulating value superior to said second thermally insulating flexible down sheet to thermally insulate said thermal energy generating membrane from an ambient temperature side of said thermal source energy transfer assembly when retained adjacent a surface area of a user person to be heated or cooled by heat or cold released by said thermal energy generating membrane, said second thermally insulating flexible down material sheet absorbing and distributing thermal energy transferred thereto by said thermal energy generating membrane against said surface area to be heated or cooled.

2. The composite light weight, flexible and energy efficient, thermal source energy transfer assembly as claimed in claim 1 wherein said thermal energy generating membrane is one of a type having a limited supply of thermal energy.

3. The composite light weight, flexible and energy efficient, thermal source energy transfer assembly as claimed in claim 2 wherein said thermal energy generating membrane is an electrically conductive circuit connected to a portable dc supply source.

4. The composite light weight, flexible and energy efficient, thermal source energy transfer assembly as claimed in claim 3 wherein said electrical circuit is an electrically conductive heating assembly secured to a flexible support sheet material and releasing heat energy when rendered conductive by the application of electrical power from said portable dc supply source.

5. The composite light weight, flexible and energy efficient, thermal source energy transfer assembly as claimed in claim 4 wherein said electrically conductive heating assembly is comprised of an electrically conductive printed circuit secured to an inner surface of a temperature conductive support sheet, said printed circuit being adapted to be connected to said power source.

6. The composite light weight, flexible and energy efficient, thermal source energy transfer assembly as claimed in claim 5 wherein said temperature conductive support sheet is a thin layer of a carbon or graphene metal or a material having similar temperature conductive properties.

7. The composite light weight, flexible and energy efficient, thermal source energy transfer assembly as claimed in claim 6 wherein said second thermally insulating flexible down material sheet has an inner surface bound in facial contact to an outer surface of said temperature conductive support sheet.

8. The composite light weight, flexible and energy efficient, thermal source energy transfer assembly as claimed in claim 7 wherein said inner surface of said second thermally insulating flexible down material sheet has a stretchable adhesive scrim sheet bonded to said inner surface thereof to bind with said outer surface of said temperature conductive support sheet.

9. The composite light weight, flexible and energy efficient thermal source energy transfer assembly as claimed in claim 4 wherein said electrically conductive heating assembly is a gel pad comprised of an envelope formed of polymeric material, and a heat absorptive substance held captive in said envelope, said thermal material assembly constituting a thermal heating pad.

10. The composite light weight, flexible and energy efficient, thermal source energy transfer assembly as claimed in claim 9 wherein said heat absorptive substance is microwave responsive particulate materials or a liquid, such as glycerol and polyethylene glycols.

11. The composite light weight, flexible and energy efficient, thermal source transfer assembly as claimed in claim 9 wherein said microwave responsive substance is a particulate material comprised of beads of activated alumina mixed with glycol and water in predetermined proportions for delivering a temperature of about 105 degrees F. or greater for 25-30 minutes when subjected to microwaves at 700 watts for 3 minutes.

12. The composite light weight, flexible and energy efficient, thermal source energy transfer assembly as claimed in claim 4 wherein said electrically conductive heating assembly is a flexible thin film heating element having an electrically conductive printed circuit formed on an electrically insulating flexible sheet material bonded to said flexible sheet material and laminated between polymer sheets.

13. The composite light weight, flexible, and energy efficient, thermal source energy transfer assembly as claimed in claim 4 wherein said second thermally insulating flexible down material sheet further absorbs heat from said surface, and sensing means to sense temperature values from said thermal energy generating membrane and said surface to be heated to provide temperature sensed signals to a controller to adjust the thermal energy generated by said electrically conductive heating assembly when said temperature value signals from said surface exceed the temperature value signals from said thermal energy generating membrane whereby to control the heat generated by said thermal energy generating membrane and thereby saving on the energy consumed by said thermal energy generating membrane.

14. The composite light weight, flexible and energy efficient, thermal source energy transfer assembly as claimed in claim 13 wherein said power source of said electrically conductive heating assembly is a rechargeable portable dc power supply.

15. The composite light weight, flexible and energy efficient, thermal source energy transfer assembly as claimed in claim 1 wherein there is further provided a thermal reflective film bonded to an outer surface of said first thermally insulating flexible down material sheet.

16. The composite lightweight, flexible and energy efficient, thermal source energy transfer assembly as claimed in claim 15 wherein said reflective film is a flexible and pliable polyester type film or “Mylar”, registered trademark, metalized on one side or thermoplastics material having a reflective side.

17. The composite lightweight, flexible and energy efficient, thermal source energy transfer assembly as claimed in claim 16 wherein said thermoplastics material is a polyethelyene terepthalate aluminized film having a reflective metal evaporated on one side of said film to give it reflective properties.

18. The composite light weight, flexible and energy efficient thermal source energy transfer assembly as claimed in claim 1 wherein said articles of warmth are one of an article of apparel, a sleeping bag, a blanket, a pad, and like articles for generating thermal energy to a body surface portion of a user person.

19. The composite light weight, flexible and energy efficient thermal source energy transfer assembly as claimed in claim 1 wherein said first and said second thermally insulating flexible down material sheets are provided with a binder exhibiting stretchability, and an outer scrim sheet secured to said first and said second thermally insulating flexible down material sheets, said outer scrim sheet having adhesive properties to bind respectively to an outer shell material and an inner lining material of said article of warmth or cold.

20. The composite light weight, flexible and energy efficient, thermal source energy transfer assembly as claimed in claim 1 wherein said thermal energy generating membrane is a heat generating membrane secured to an electrical supply source and for use in articles of warmth for generating heat into an area to be heated to provide comfort to user persons.

21. The composite light weight, flexible and energy efficient, thermal source energy transfer assembly as claimed in claim 1 wherein said thermal energy generating membrane is incorporated in the construction of road and air transport vehicles.

22. The composite light weight, flexible and energy efficient thermal source energy transfer assembly as claimed in claim 1 wherein said second thermally insulating flexible down material sheet is comprised of down material mixed with a binder material and heat conductive fibers.

23. A method of constructing a composite light weight, flexible and energy efficient, thermal source energy transfer assembly for the transfer of thermal energy in articles of warmth or cold against a surface area to be heated or cooled, said method comprising the steps of:
i) providing a thermal energy generating membrane capable of generating thermal energy, said thermal energy generating membrane having opposed top and bottom surfaces,
ii) bonding a first thermally insulating flexible down material sheet to said top surface of said thermal energy generating membrane,
iii) bonding a second thermally insulating flexible down material sheet to said bottom surface of said thermal energy generating membrane, said first thermally insulating flexible down material sheet having a thermal insulating value superior to said second thermally insulating flexible down sheet to thermally insulate said thermal energy generating membrane from an ambient temperature side of said thermal source energy transfer assembly, and further wherein said second thermally insulating flexible down material sheet absorbs and distributes thermal energy transferred thereto by said thermal energy generating membrane against said surface area to be heated or cooled.

24. The method as claimed in claim 23 wherein said step (i) comprises providing an electrical thermal energy generating membrane and wherein there is further provided the steps of (a) connecting an electrical power supply to an electrical heat generating conductor(s) of said electrical thermal energy generating membrane through switch means, and (b) controlling the supply of electricity from said power supply.

25. The method as claimed in claim 24 wherein there is further provided the steps of (iii) bonding a first temperature sensor between said first thermally insulating flexible down material sheet and said top surface of said thermal energy generating membrane, (iv) bonding a second temperature sensor on an outer surface of said second thermally insulating flexible down material sheet to sense temperature transferred against said surface area to be heated, said first and second temperature sensors feeding temperature value signals to a controller which operates said switch means to regulate the voltage supplied by said electrical power supply to said thermal energy generating membrane to maintain a substantially constant desired temperature against said surface are to be heated.

26. The method as claimed in claim 23 wherein there is further provided the step of bonding a thermal reflective film against an outer surface of said first thermally insulating flexible down material sheet to reflect heat from said first thermally insulating flexible down material sheet in the direction of said thermal energy generating membrane.

27. The method as claimed in claim 23 wherein said step (i) comprises providing a thermal energy generating membrane of a type having a limited supply of heat or cold thermal energy, said membrane being in the form of a pad or pouch containing therein a substance capable of absorbing heat from microwave energy or absorbing cold from a cold chamber and releasing said heat or cold against said surface to be heated or cooled.

28. A composite light weight, energy efficient, thermal source energy transfer assembly for the transfer of thermal energy in a space to be heated or cooled to provide comfort, said thermal source energy transfer assembly comprising a thermal energy generating membrane having oppose inner and outer surfaces, a first thermally insulating flexible down material sheet secured to said outer surface, a second thermally insulating flexible down material sheet secured to said inner surface and wherein said first thermally insulating flexible down material sheet has a thermal insulating value superior to said second thermally insulating flexible down sheet to thermally insulate said thermal energy generating membrane from an external temperature side of said thermal source energy transfer assembly, said first thermally insulating flexible down material sheet being bonded to a surface area of a support structure, said second thermally insulating flexible down material sheet having a thermal energy conductive membrane secured to an outer surface thereof, said second thermally insulating flexible down material sheet absorbing and distributing thermal energy transferred thereto by said thermal energy generating membrane and releasing the thermal energy in a controlled manner through said thermal energy conductive membrane into an adjacent space to be heated or cooled.

29. The composite light weight, and energy efficient, thermal source energy transfer assembly as claimed in claim 28 wherein said thermal energy generating membrane is a heat generating membrane comprised of an electrically conductive circuit connected to a dc supply source.

30. The composite light weight, energy efficient, thermal source energy transfer assembly as claimed in claim 28 wherein said thermal energy generating membrane is a heat generating membrane and wherein there is further provided a heat reflective material sheet bonded between said surface area of said support structure and said first thermally insulating flexible down material sheet to reflect heat back into said first thermally insulating flexible down material sheet to minimize heat loss through said support structure.

31. The composite light weight, energy efficient, thermal source energy transfer assembly as claimed in claim 30 wherein said thermal energy conductive membrane is an outer surface material capable of absorbing heat and secured to an outer surface of said second thermally insulating flexible down material sheet, said support structure being a composite heat generating panel for use in building structures, transport land vehicles and aircrafts, and other applications whereby to efficiently provide heat for the comfort of occupants of such buildings, vehicles and aircrafts or other applications.

32. The composite light weight, and energy efficient, thermal source energy transfer assembly as claimed in claim 28 wherein said thermal energy generating membrane is a cold energy generating membrane comprised of a refrigerant circuit retained between said first and second thermally insulating flexible down material sheet.

33. The composite light weight, energy efficient, thermal source energy transfer assembly as claimed in claim 28 wherein said thermal energy generating membrane is a cold energy generating membrane and wherein there is further provided a cold energy reflective material bonded between said surface area of said support structure and said first thermally insulating flexible down material sheet to reflect cold energy back into said first thermally insulating flexible down material sheet to minimize cold energy loss through said support structure.

34. The composite light weight, energy efficient, thermal source energy transfer assembly as claimed in claim 33 wherein said thermal energy conductive membrane is an outer surface material capable of absorbing cold energy and secured to an outer surface of said second thermally insulating flexible down material sheet, said support structure being a wall structure of a refrigerated enclosure or a space to be cooled for the comfort of occupants.

35. The composite light weight, energy efficient, thermal source energy transfer assembly as claimed in claim 33 wherein said reflective material is comprised of a composite material sheet having opposed reflective surfaces, one of said reflective surfaces facing said first thermally insulating flexible down material sheet to reflect cold energy back into said first thermally insulating flexible down material sheet and the other of said reflective surfaces facing said external temperature side of said thermal source energy transfer assembly to reflect external temperature back into said support structure.
